(19) United States
(12) Patent Application Publication
(10) Pub. No.: US 2008/0218335 A1
(43) Pub. Date: Sep. 11, 2008

(54) RFID BASED PROXIMITY SENSOR AND ALERT SYSTEM FOR FUGITIVES, SEX OFFENDERS, MISSING SOLDIERS AND THE LIKE

(76) Inventor: Amir J. Attar, Raleigh, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 11/682,069

(22) Filed: Mar. 5, 2007

(51) Int. Cl. G08B 1/08

(52) U.S. Cl. 340/539.13; 340/539.11; 340/539.17

(57) ABSTRACT

A robust, wireless sensor system providing a low cost method of tracking people such as sex offenders, child molesters, etc., after their release from prison or other confinement, which protects society from such individuals and lessens their ability to repeat such offenses. The system and method of the invention can also be used to locate kidnapped persons, people buried in snow avalanches, missing or dead soldiers, etc. The system utilizes RFID tags placed on people or in specified locations and RFID transmitters that can resonate with the tagged people or objects. Such a trigger recognition arrangement combined with communication of information from the triggering can be used to obtain a signal alerting the transmitter carrier that the tagged object or person is nearby. The triggering action can also initiate a sequence of information transfers in which the transmitter broadcasts to a central command that a particular transmitter is or was in proximity to a specific object or person, and allows the command center to order the dispatch of authorized personnel, such as policemen, military personnel, emergency rescue workers, etc. to the triggering location.

### BACKGROUND OF THE INVENTION

The question of disposition of criminals such as sex offenders and child molesters after they have completed their legal sentences after incarceration and are to be released as persons able to freely locate and travel in society, has pitted social norms and legal principles against each other, particularly in view of research and findings of widespread recidivism and renewed criminal activity of sex offenders after such release, particularly with regard to sex crimes against children. The consequences of such renewed criminal activity include physical injury, tragic loss of life, psychological trauma, and lost innocence of children, and therefore entail a very significant social issue.

Similar questions of societal harm arise in the context of severely dysfunctional family and interpersonal relationships, where there is a history or emergence of violence and intimidation directed against family members or romantic partners. Such circumstances may result in a threatened party obtaining a restraining order from a court. The restraining order may limit the physical proximity of the abusive person to the threatened party or parties, but existing conditions make enforcing such an order very difficult. Numerous cases have been documented in which a husband or boyfriend violated a restraining order but by the time police were notified and arrived at the location of the violation, the spouse, girlfriend and/or children were murdered or suffered grievous bodily injury.

It therefore is a fact that threats and intimidation are made and continue in violation of legal sanctions and protections, and that violence and the potential for violence are sufficiently pervasive as to warrant fundamental re-examination of the conventional systems that are utilized to protect innocent persons against harm and threats of harm from abusive family members and others known to have a propensity for violence.

### SUMMARY OF THE INVENTION

The present invention relates to a tracking system for monitoring sex offenders and other criminals and alerting the police in a timely manner when such persons come into sufficient physical proximity to potential victims as to present a threat to the health and safety of such potential victims. In addition to saving lives and reducing crime, this system will reduce the costs of trying, sentencing and incarcerating such offenders. The present invention provides a solution that permits released offenders and criminals to retain their freedom, while alerting the police in a timely way when they attempt, or are in a circumstance or position to commit, a new crime.

The present invention relates to a control and alerting system which permits released offenders, angered spouses, etc. (hereafter “criminal”), to retain their freedom of movement, yet advise the authorities very quickly if the criminal has violated a court order and/or is in a physical position to commit a crime. The system includes four components:
A. RFID tags placed on potential victims or in specific locations where the criminal is not allowed to frequent. These tags are often passive RFID, and are denoted TT for target tags.
B. Active RFID transmitter-receiver pairs placed on the potential offenders, much like the bracelets used in home incarceration. These bracelets allow their bearer to move freely, but are continually looking for TT in their vicinity. These RFID transmitters/bracelets are denoted AT for active transmitters.
C. A central command with a data base and a capacity to receive messages and dispatch police or other responders to specified locations. These centers are denoted CC, for command centers. The CC unit is designed to receive signals from multiple transmitters simultaneously.
D. Local police or other authority entities, AE, which can communicate with the CC and dispatch police or other response personnel to the location where the transmitter, (AT), and receiver, (TT), interacted.

In a typical embodiment of the technology of the present invention, the tracked criminal, e.g., a released sex offender, a disgruntled spouse, etc., is equipped with a bracelet or a similar attachment to his body (hereafter “bracelet”). The bracelet contains at least the following five components:

1. a transmitter that connects the bracelet wirelessly, via a telephone line or via another form of hard wire or communication infrastructure, to a central control room.

2. an active RFID source that continually interrogates the area close to the bracelet looking for other RFID devices.

3. an RFID receiving antenna that accepts the signal from the excited TT.

4. a tamper-sensor which activates the transmitter if the bracelet is removed or tampered with, and

5. a battery alert to tell the criminal that his bracelet battery is almost exhausted and needs replacement and alerts the CC where the criminal is, the status of his battery and the need for battery replacement. If the battery is not replaced in time, a second alarm may be issued and accompanied by a dispatch of police personnel.

As a possible sixth component, the bracelet may incorporate a Global Positioning System (GPS), to help locate the bracelet carrier.

The complementary components of the system are target RFID transmitters, and the TT, which are often passive RFIDs. The TTs may be placed in stationary places like a child's playground, or on people such as threatened wives or children. When the bracelet-carrying criminal comes into close proximity to a TT, the signal from its transmitter recognizes the TT by its frequency and learns at least two pieces of information: it establishes that the offender is in close proximity to the target, and it determines the target location and/or identity. The location is determined via a transmitted code from the TT or by the GPS component in the bracelet. This information, together with the offender's code, is instantly and automatically transmitted to the command center, most preferably wirelessly.

The Command Center, CC, has four interacting data bases, a receiver and transmission-dispatching capabilities. The data bases are:
1. The offenders' codes and the corresponding information on each offender, including name, address, type of criminal activity, etc. This data base is denoted Criminals Data Base, or CDB.
2. The Target Tags Data Base, (TTDB), where each tag code is associated either with a person or with a location. For example, code 15,001 may be associated with a tag placed on the corner of Main and Elm near a children's playground. Code 60,007 may be associated with Ms. Julie Smith who is afraid of her estranged husband who threatened to kill her. Each TT code will be associated with relevant information such as address, people names, etc. This data base is denoted Locations Data Base or LDB.
3. The police units and/or other authorities associated with a given TT location or with a person. The police units have to be the closest department to the location where the proximity alert took place. This data base is denoted Police Data Base, or PDB.
4. In specific cases, it may be prudent to have a data base of parents or relatives of potential victims and to be able to alert them to go immediately to a given location, to come to the police station, etc. This data base is denoted Associates Data Base or ADB.

Once the CC receives an alarm, it immediately identifies the offender, the location of the proximity contact and the closest authority that may be contacted and summoned to help at such location. The CC then immediately and automatically issues instructions to the relevant police department to dispatch people to the crime location and submits to them a file with the relevant information on the criminal, the victim, probation officers, etc. The fact that a criminal has violated a proximity order, e.g., a child molester has entered a children playground, is recognized instantly and may mean the difference between life and death, as relevant authorities are dispatched instantly and automatically. The system therefore accommodates the fact that the first few minutes and hours of such crimes are the most critical ones, with most victims being violated in the course of that first contact. The dispatched officers will have then with them: 1. the identity of the criminal, 2. his location, 3. a time stamp of the event, 4. the type of location where the criminal entered and/or the name and ID of the child near him.

In one embodiment, the target tag, TT, is placed in critical locations such as children's play grounds, schools, children's activity places such as after school clubs, etc.

In one embodiment, the target tag, TT, is placed on people such as children and warns the police and/or their parents if an offender comes close to them.

In another embodiment of the present invention, the target tag, TT, is an active device capable of communicating also with the CC, and is placed on people such as threatened spouses or children, to warn them and the police and/or their parents if an offender comes close to them.

In still another embodiment of this invention, the CC continually probes the ATs and obtains a signal back that identifies the transmitter and records its location. This configuration permits a continual tracking and recording of criminal locations with only a minimal physical intrusion on their daily routine. When the CC receives data from an AT indicating that the AT is in a close proximity to a TT, the CC can provide the investigators with a trace of the locations where the criminal has been. This information can be related to investigating authorities as a part of a criminal investigation of a crime, had the criminal been successful.

In one embodiment, the CC maintains a database that also includes a map of the area including for example schools, playgrounds, and locations relevant to the particular crime. These locations are denoted Forbidden Areas. Should the criminal enters a FA, the CC can immediately alert the authorities and dispatch police to the location, and thus avoid a potential crime before it happens.

In another embodiment of this invention, the CC may include a two-way communication system with the AT-carrying criminal. If the criminal enters a forbidden zone, the CC can give the criminal a warning signal to tell him that he is violating the conditions of his freedom, that he is being watched and that he must move away before the police arrive. A simultaneous or subsequent step may include dispatching police personnel to the area.

Another variant of the embodiment of this invention includes tagging solders or civilians with TT. The TT may for example be attached to a soldier, incorporated in clothing or equipment worn by such individual, or even introduced subcutaneously into his body. If the soldier is kidnapped, lost, or hidden, a search party can easily locate him even without first establishing visual contact. A search party with AT can detect the location of the kidnapped person very easily if he is tagged.

### BRIEF DESCRIPTION OF THE DRAWINGS

FIG. 1 is a schematic diagram of a base configuration of the present invention, in one embodiment thereof, showing the various elements that it includes and how they communicate with and relate to each other.

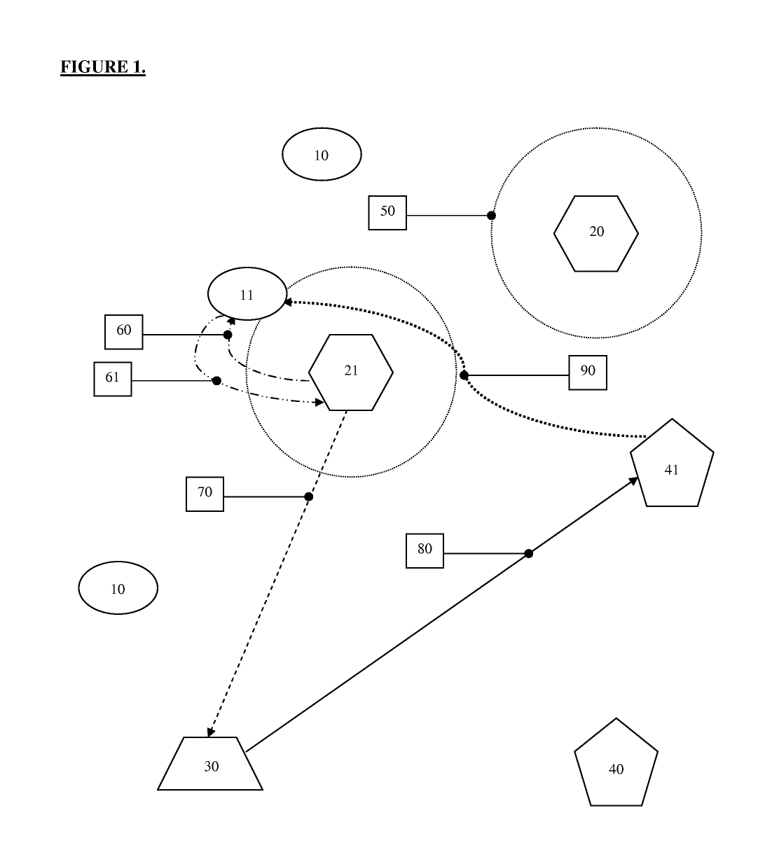

FIG. 2 shows how one embodiment of the present invention can be used as a two-way system that alerts sensitive potential victims when a criminal comes close to them.

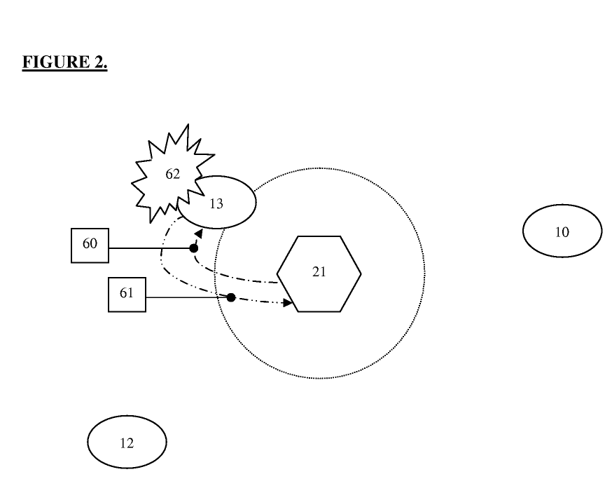

FIG. 3 illustrates how a subsystem of the present invention, in one embodiment thereof, can be used to locate tagged kidnapped solders, missing or kidnapped children, or kidnapped personnel such as oil field workers in foreign countries and alike.

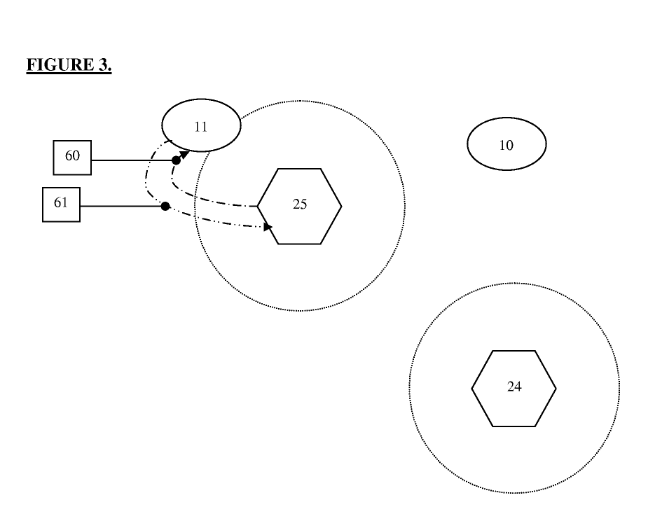

FIG. 4 shows an embodiment of the system in FIG. 3 in which communication is held between the search party and a central command.

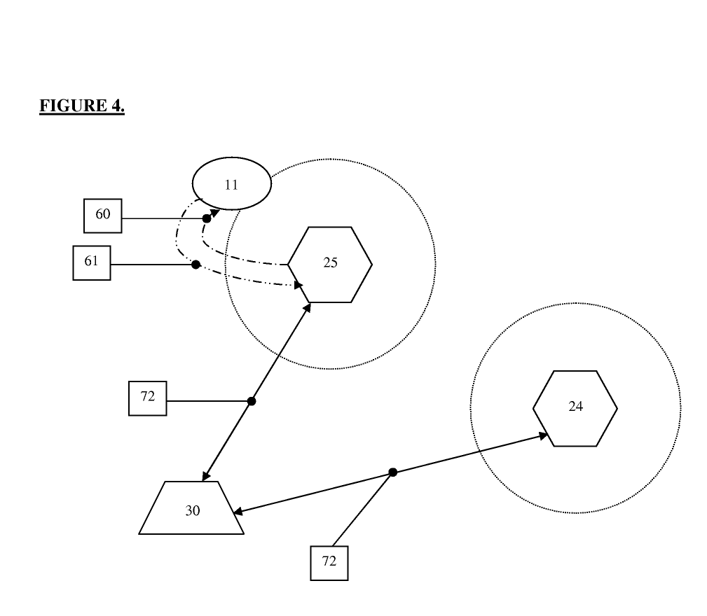

FIG. 5 is a block diagram showing how a combination of a GPS and a transmitter can be used to warn police when a criminal enters a forbidden zone even before any crime is committed.

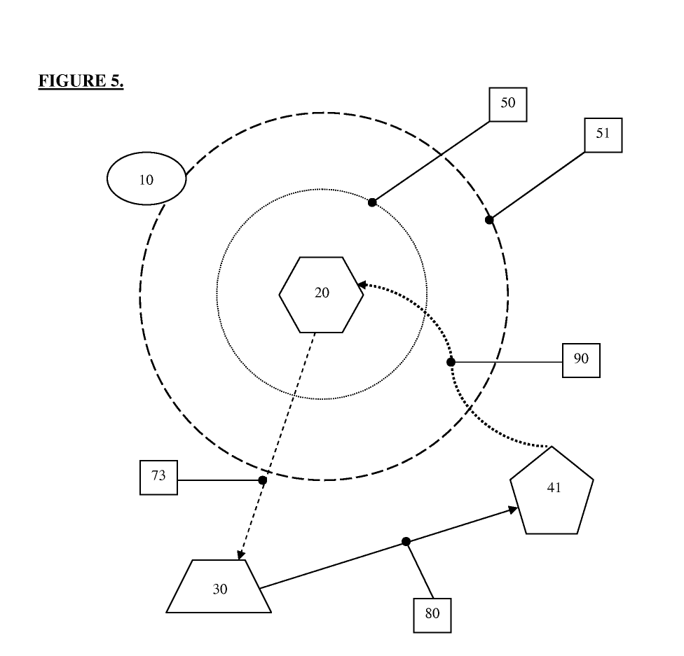

FIG. 6 is a block diagram showing how a combination of a GPS and a transmitter can be used to warn school administrators when a tagged criminal enters school premises, or warn threatened spouses when the offender comes close to them.

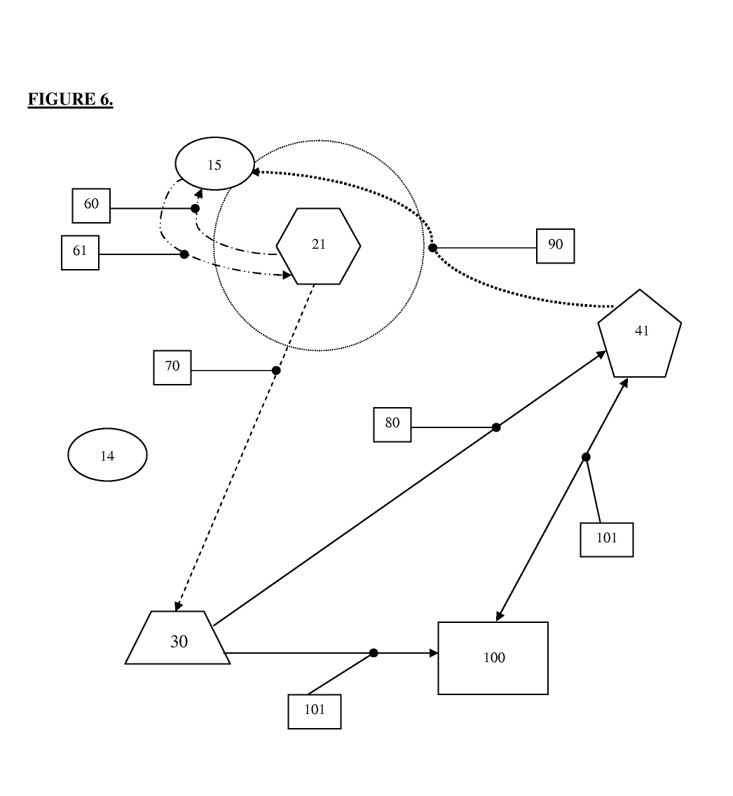

FIG. 7 is a block diagram of an urban area showing how a CC located within a city can monitor offenders within its jurisdiction, keeping track of their location, battery status, etc., by regularly and periodically polling their bracelets.

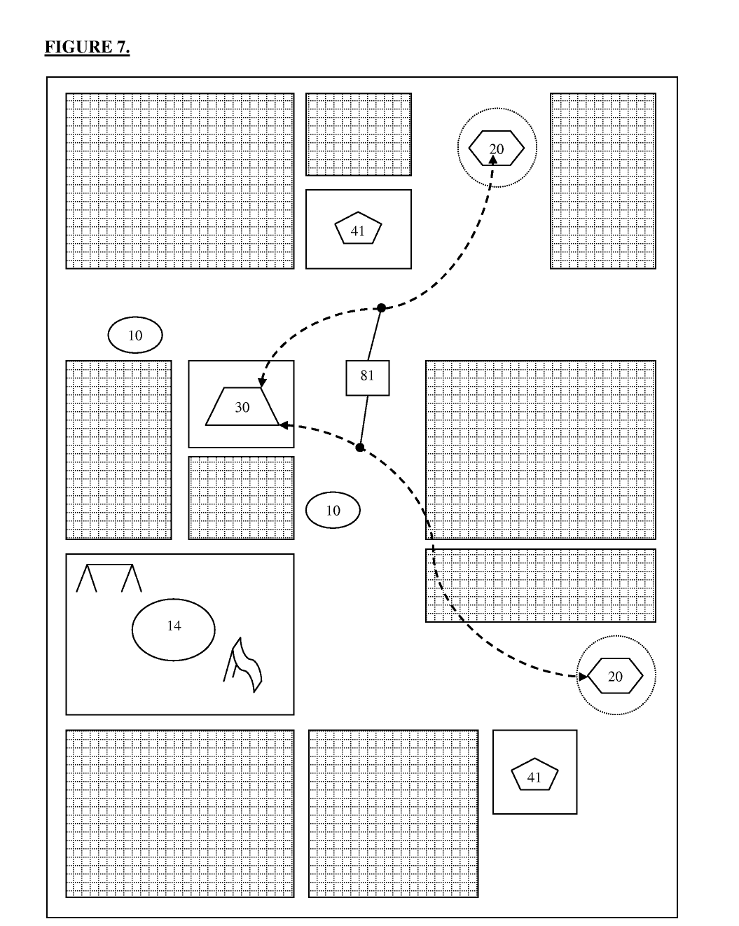

FIG. 8 is a block diagram showing how police departments can be set up within a CC jurisdiction to efficiently recognize the nearest AE, and to alert and dispatch authorities to the alarm location.

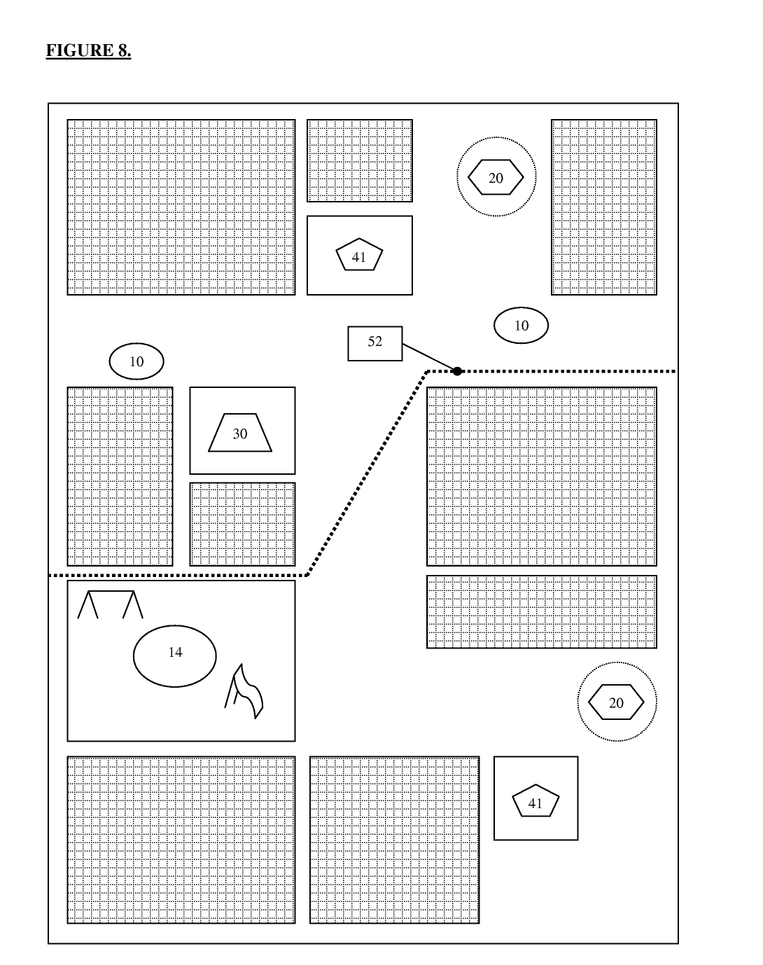

### DETAILED DESCRIPTION OF THE INVENTION, AND PREFERRED EMBODIMENTS THEREOF

The nomenclature used in all the diagrams described hereafter includes the same elements. The various elements are:
10. RFID on potential victim, missing individual or location with Passive RFID capabilities (TT)
11. RFID on potential victim, missing individual or location with Passive RFID capabilities (TT), that is in range of an Active RFID
12. RFID on potential victim with passive and active RFID capabilities, as well as wireless reception capability
13. RFID on potential victim with passive and active RFID capabilities, as well as wireless reception capability, that is in range of an Active RFID
14. RFID on specified location, such as a forbidden zone such as a child's playground, with passive RFID capabilities
15. RFID on specified location with passive RFID capabilities, that is within range of a possible offender
20. RFID on possible offender with active RFID and CC communication capabilities (AT)
21. RFID on possible offender with active RFID and CC communication capabilities (AT), that is in range of a Passive RFID
22. RFID on possible offender with active RFID, CC communication, and GPS capabilities
23. RFID on possible offender with active RFID, CC communication, and GPS capabilities, that is in range of a Passive RFID
24. RFID carried by search party with active RFID for locating missing persons
25. RFID carried by search party with active RFID for locating missing persons that is in range of a Passive RFID
30. Command Center (CC)
40. Police Station
41. Police Station nearest the location of victim/offender interaction
50. Range of active RFID on possible offender or search party
51. Warning Zone for possible offenders close to, but not violating law
52. Zone of Police Department within a CC jurisdiction
60. Active RFID signal (captured by passive or active RFID on potential victim, location, or missing person)
61. Passive RFID return signal (returns to Active RFID with information on potential victim, location, or missing person the passive RFID is located on)
62. Noise or alert on active RFID on victim or school administrator near location of potential targets
70. Signal from offender to CC with data on potential victim/location and possible offender
71. Signal from offender to CC with data on victim, offender, and GPS data
72. Communication between search party and CC while searching for missing person, with data on location, other search parties, results
73. Signal from offender to CC with GPS data on offender, which is checked for proximity to target locations/persons
80. Data transmitted from CC to police station nearest the scene of contact (includes victim, offender, auxiliary information, and possibly GPS)
81. Polling between the CC and Active RFID of possible offender with data on offender location.
90. Police/authorities dispatched to location to apprehend suspect
100. School administrator/staff
101. Contact with school administrator/staff with notification and data on offender
102. Communication between school administrator/staff with local police in regards to offender's presence

It will be evident to those skilled in the art that the invention is not limited to the details of the foregoing illustrated embodiments and that the present invention may be embodied in other specific forms and applications without departing from the spirit or essential attributed thereof; furthermore, various omissions, substitutions and changes may be made without departing from the spirit of the inventions.

What is claimed is:

1. A wireless tracking system, comprising:
one or more objects or people tagged with RFID devices, TT,
an active RFID transmitter-receiver, AT, that can communicate with the TT's when it comes in close proximity to them,
a transmitter adapted to send to a central command unit, a CC, a signal identifying the TT and the AT once they establish communication with each other,
a central command unit, CC, adapted to receive identifying information from the AT's, compare the information to data bases, make proper conclusions and alert authorities of occurrence details, and
an authority entity or entities, AE, adapted to receive signals from the CC and dispatch response personnel to the location of the occurrence.

2. The system of claim 1 wherein the AT is attachable to a person.

3. The system of claim 1 wherein the AT is attachable to a person and is equipped with a tamper sensor so that if the AT is deactivated or removed in an unauthorized way, it alerts the CC.

4. The system of claim 1 wherein the power source of the AT is attachable to a person and alerts its carrier and/or the CC when available power gets low and the battery needs recharging.

5. The system of claim 1 wherein the TT and/or the AT are adapted to provide location information associated with an alarm.

6. The system of claim 1 further comprising a means of identifying the location, wherein said means comprise a global positioning system (GPS) embedded in the AT.

7. The system of claim 1 where at least one of the TT's comprises a passive RFID.

8. The system of claim 1 where at least one of the TT's comprises an active RFID.

9. The system of claim 1 wherein the signal from the AT is transmitted to the CC wirelessly directly or via one or more interim transfer stations or repeaters.

10. The system of claim 1 wherein the AT comprises:
a transmitter that connects the AT wirelessly, via a telephone line or via another form of hard wire to a central control room.
an active RFID source that continually interrogates and area close to the AT looking for other RFID devices,
an RFID receiving antenna that accepts the signal from the excited TT.
a temper-sensor that activates the transmitter if the AT is removed or tampered with, and
a battery alert to inform a wearer that his AT battery is approaching an exhausted state and needs to be replaced and alert the CC where the wearer is, the status of his battery and the need that for battery replacement, optionally with a further alert to the wearer that if the battery is not replaced within a predetermined time, then a further alarm may be issued and accompanied by dispatch of police authorities.

11. The system of claim 1 wherein the CC contains a data base containing relevant information of all potential offenders, as a Criminals Data Base (CDB).

12. The system of claim 1 wherein the CC contains a data base containing relevant information of all tags placed in various locations or on people, and relevant information associated with each TT, so that it can be made available to the EA when an alarm occurred, as a Target Tags Data Base (TTDB).

13. The system of claim 1 wherein the CC contains a data base containing the relevant information of all responsible parties associated with specific TT's, as an Associates Data Base (ADB)

14. The system of claim 1 wherein the CC contains a data base containing a map of its jurisdiction area defining and associated AE's with specific locations, and defining priorities or order of AEs to be called in a case of an alarm, as an Associates Map Data Base (AMDB).

15. The system of claim 1 wherein the CC contains a data base containing relevant information of all potential authorities and AE, their capabilities and specific responsibilities relative to specific potential victims and/or responsibility to specific potential crime locations, as a Police Data Base (PDB).

16. The system of claim 1 wherein the CC routinely polls some or all of the ATs associated with it to determine that they are functioning, their locations, the strength of their batteries and/or other relevant information.

17. The system of claim 1 wherein the CC contains an algorithm for associating a specific AE with specific locations in the CC jurisdiction area and having the ability to supply the AE with information on potential offenders, potential victims and other relevant information, as they are being dispatched to the alert location.

18. The invention of claim 1 wherein the CC contains an algorithm associating specific AT with specific locations in the CC jurisdiction area and having the ability to warn AEs that a potential offender is in a forbidden zone, and to alert a potential offender that he is in a forbidden zone and thus should leave before AE personnel enter said zone.

19. The system of claim 1 wherein the ATs are placed on known sex offenders or child molesters to permit them freedom while protecting the community.

20. The system of claim 1 wherein TT are adapted to be placed on a threatened victim to alert the AE and the potential victim that a threatening party came into close proximity to the threatened victim.

21. The system of claim 1 wherein TT is placed in specific locations in dwellings or work places or cars of a threatened victim or on other locations associated with the threatened victim to alert police and the threatened victim if a threatening party comes in a close proximity thereto.

22. The system of claim 1 wherein TT's are placed on people and/or on their clothing, while present in a danger zone in which they are susceptible to being kidnapped, to permit search parties equipped with a TA to locate them.

23. The system of claim 1, where the TT's are placed on soldiers, news reporters, or contractors to facilitate a search for them.

24. The system of claim 1 wherein the TT's are placed on mountain climbers, skiers, or hikers to facilitate locating them when lost or isolated from discovery.

25. The system of claim 1 wherein the TT's are placed on children to facilitate locating them when lost or missing.

26. The system of claim 1 wherein the TT's are placed on persons in a nursing home to facilitate locating them when they are lost or missing.
